(19) United States
(12) Patent Application Publication
(10) Pub. No.: US 2002/0154822 A1
(43) Pub. Date: Oct. 24, 2002

(54) Process for compression of digital image data

(75) Inventors: Ehud Nachtomy, Givataim (IL); Victor Rutman, Petach Tikva (IL)

Correspondence Address: DR. MARK FRIEDMAN LTD., c/o BILL POLKINGHORN`, 9003 FLORIN WAY, UPPER MARLBORO, MD, 20772, US

(73) Assignee: MEDCON TELEMEDICINE TECHNOLOGY

(21) Appl. No.: 09/799,590

(22) Filed: Mar. 7, 2001

(51) Int. Cl. G06K 9/36; G06K 9/46; G06K 9/20

(52) U.S. Cl. 382/232; 382/282

(57) ABSTRACT

A method for compression of digital data representing a series of time-dependent images (frames) of an object of interest, as might be produced by an X-ray angiography imaging system of a cardiovascular process. The amount of data is reduced with only an insignificant reduction of the relevant information content therein. According to one aspect of the invention, the method compresses the data by isolating only data pertaining to an object of interest. The excess data, that which is not isolated, is discarded or otherwise compressed. According to a second aspect of the invention, if the data represents a series of periodic time-dependent images the period of the series and an optimal first frame are determined. Thereafter, only one such period is retained. The period is determined by determining the period of a closeness function of consecutive frames. The optimal first image is determined from an extremum in the closeness function.

### FIELD AND BACKGROUND OF THE INVENTION

The present invention relates to a method for compressing digital data representing a series of time-dependent images of an object of interest.

X-ray angiography is a well-known method in medical imaging. When employed in a catheterization lab, this technique is usually used for imaging blood and particularly coronary and peripheral blood vessels for diagnostic purposes or for guiding and monitoring a multitude of invasive procedures such as PTCA or stent deployment.

Injection of an X-ray opaque contrast material is necessary for observing blood vessels using X-ray angiography. When the contrast material is present in a blood vessel, its detection delineates the internal surfaces of the vessel allowing an image of the vessel to be recorded. Typically, after a contrast material is injected into the vessel of interest the X-ray system is activated in order to record an image of the vessel. In the few seconds during which the contrast material flows through the vessel a set of successive X-ray frames are recorded in what is termed as an angiographic run. During the course of a coronary or peripheral X-ray angiography procedure typically a set of 10 to 20 runs is produced.

Although the cardiologist views the angiographic runs in cine mode (one frame after the other in quick succession) during the catheterization procedure, the runs are also stored and later used by physicians for reporting surgery planning, long term comparisons and clinical monitoring purposes. There can also be legal requirements for retaining an angiographic run for a period of several years.

In the past, angiographic runs were stored using canalog media but digital media are becoming increasingly popular. The digitization of angiographic runs enables convenient computer-aided retrieval, viewing and processing.

Digitization also introduces the possibility of efficient transmission of an angiographic run by electronic means. Efficient transmission is important when consultation between two physicians regarding an angiogram is needed. Currently, a major obstacle for efficient transmission is communication bandwidth. An average catherization procedure produces a set of X-ray angiographic runs requiring about 250 MB of data when compressed by non-lossy schemes but can even reach 600 MB. Sending such a volume of data over standard telephone or ISDN lines, or for example, over the Internet, is not practical. Even sending a single angiographic run, typically more than 10 MB, is not practical. There is a need to reduce the amount of data representing an angiographic run to allow efficient electronic transmission and to reduce the cost of data storage.

For data such as angiographic runs, known compression methods for reducing the amount of data such as JPEG, MPEG or Wavelet are unsuitable as they are lossy (image quality is reduced after compression and decompression), compromising the medical usefulness of runs so compressed. Known loss-less algorithms are insufficient, compressing angiographic image data by no more than a factor of 2 or 3.

There is therefore a need for significantly reducing the amount of data representing an angiographic run with only insignificant reduction in the quality of medical information therein.

### SUMMARY OF THE INVENTION

It is the purpose of this invention to reduce the amount of digital data representing a time-dependent series of images with only an insignificant reduction of the relevant information content therein. The use of this invention can best be understood by considering a typical use, the reduction of the amount of data of an X-ray angiographic run where often a single heartbeat contains sufficient information for a physician to make a diagnosis or a clinical decision.

Thus the present invention provides a method for compressing digital data representing a series of periodic time-dependent images of an object of interest by (a) taking a series of digital frames which represents the series of periodic time-dependent images, (b) identifying the number of frames corresponding to one period, (c) designating an optimal first frame and (d) isolating the number of frames corresponding to one period starting with the optimal first frame as the desired compressed digital data. Thereafter, this compressed data can be displayed, stored or transmitted.

According to a further feature of the present invention, the data representing each image is compressed by a) centering the image of the object of interest in each frame (centering) b) stabilizing the image of the object of interest in each frame (tracking and steadying the image) and c) reducing the amount of data required to represent each image by substantially retaining only the image of the object of interest in each frame (digital zoom). Centering, tracking, steadying and zooming-in of the image of the object of interest allows an optimal definition of reduced frames from the original frames which include the image of the object of interest. Extraneous information outside this reduced frame can be discarded or compressed by use of methods known in the art, such as JPEG, MPEG or Wavelet.

According to a further feature of the present invention, identification of the number of frames corresponding to one period is done by a) determining a closeness function of the frames, b) deriving the periodicity of the closeness function and c) deriving the number of images in one period from the periodicity of the closeness function.

According to a still further feature of the present invention, determination of the optimal first frame is done by a) identifying the value in the closeness function which corresponds to the greatest similarity between two consecutive frames and b) designating the second of the two to be the optimal first frame. When the reduced series of images is viewed in continuous cine mode, the motion appears without jumping when passing from the last to the first image.

According to a still further feature of the present invention, the data to be compressed is recorded, for example, by imaging means, preferably by a medical imaging device, and most preferably by an Angiography X-ray imaging system, an echocardiography imaging system or an ultrasound image system.

According to a still further feature of the present invention, the invention can be applied on images that are transferred to a Picture Archiving and Communications System or on digital data representing the images that are transferred to a Picture Archiving and Communications System.

There is also provided according to the teachings of the present invention a method for compressing digital data representing a series of time-dependent images of an object of interest by (a) taking a series of digital frames which represents the series of periodic time-dependent images, and (b) generating the desired compressed digital data by reducing the data representing each image by methods including (i) centering the image of the object of interest in each fiame (centering) (ii) stabilizing the image of the object of interest in each frame (tracking and steadying the image) and (iii) reducing the amount of data required to represent each image by substantially retaining only the image of the object of interest in each frame (digital zoom). As described above centering, tracking, steadying and zooming-in of the image of the object of interest allows an optimnal definition of reduced frames from the original frames that include the image of the object of interest. Extraneous information outside this reduced frame can be discarded or compressed by use of methods known in the art, such as JPEG, MPEG or Wavelet. Thereafter, this compressed data can be displayed, stored or transmitted.

According to a still further feature of the present invention, the data to be compressed is recorded, for example, by imaging means, preferably by a medical imaging device, and most preferably by an Angiography X-ray imaging system, an echocardiography imaging system or an ultrasound image system.

According to a still further feature of the present invention, the invention can be applied on images that are transferred to a Picture Archiving and Communications System or on digital data representing the images that are transferred to a Picture Archiving and Communications System.

### BRIEF DESCRIPTION OF THE DRAWINGS

The invention is herein described, by way of example only, with reference to the accompanying drawings, wherein:

FIG. 1 is a schematic drawing illustrating the results of tracking an image of an object of interest in a series of frames to generate a series of reduced frames;

FIG. 2 is a schematic drawing illustrating the results of steadying an image of an object of interest in a series of frames to generate a series of reduced frames;

FIG. 3 is a schematic drawing illustrating the results of zooming-in on an image of an object of interest in a series of frames to generate a series of reduced frames; and

FIG. 4 is a schematic drawing illustrating steps of the second feature of the present invention.

### DETAILED DESCRIPTION OF THE INVENTION

The principles and operation of the method according to the present invention may be better understood with reference to the drawings and the accompanying description. Before turning to the details of the present invention, it should be appreciated that the present invention provides two sets of features, each of which may be used alone, or which may be combined to provide a particularly useful method for data reduction.

The first feature relates to a method of reducing the amount of digital data representing a time-dependent series of images, where the relevant information can be found in a small area of the frames, representing only the image of the object of interest. An example is the series of frames making up an X-ray angiographic run where the object of interest is an artery or a part of it depicting, for example, a lesion or stenosis. According to the present invention, this is done by deriving a reduced frame from each frame in the series. Each reduced frame substantially contains only the image of the object of interest and the data corresponding to the rest of the frame are discarded or compressed by methods known in the art, such as JPEG, MPEG or Wavelet.

The second feature relates to a method of reducing the amount of digital data representing a periodic time-dependent series of images, where all the relevant information can be found in one period of the motion of an object of interest, without reducing the relevant information content of the series. An example is the series of frames making up an X-ray angigraphic run where the period of motion is one cardiovascular cycle. According to the present invention, this is done by identifying the period of the motion and retaining only a reduced series of frames corresponding to one period of the motion that contains the relevant information for further use.

When both features of the present invention are used together, it is most preferable to define the reduced series of frames according to the second feature of the invention and thereafter to define reduced frames according to the first feature of the invention.

Further use such as displaying, storing, transmitting or otherwise manipulating the data becomes easier due to the significantly reduced amount of the data.

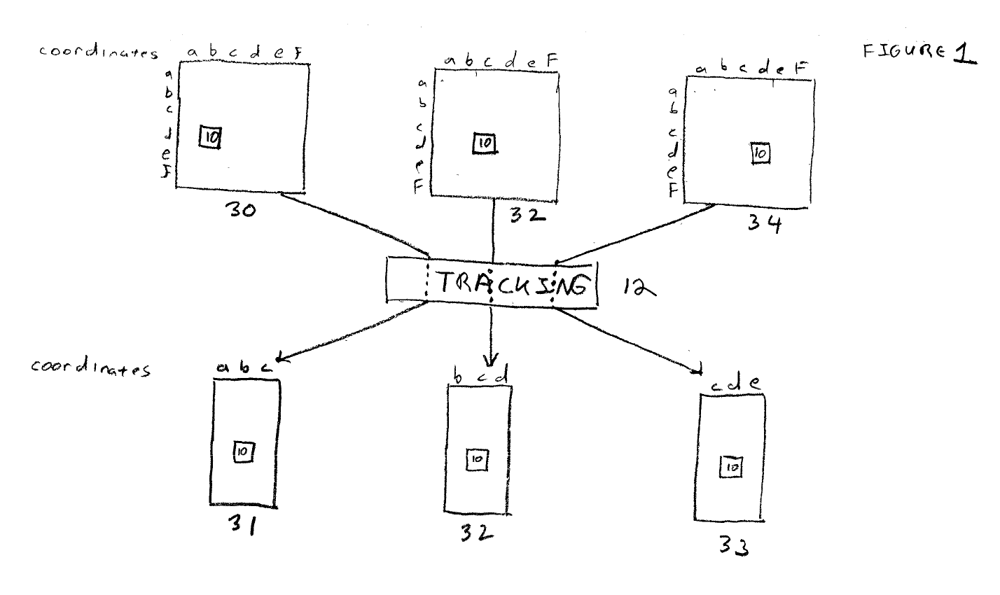

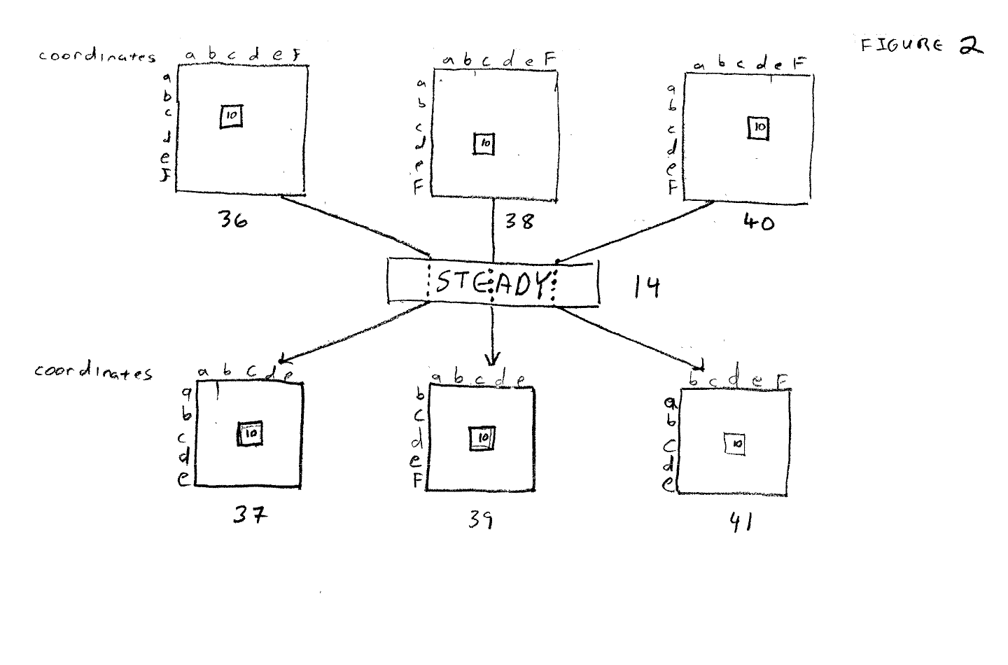

In X-ray angiography, interframe motion typically originates from camera motion or from physiological vibration due to heart contraction or breathing. Compensation for this or other interframe motion (tracking, FIG. 1 and steadying the image, FIG. 2, respectively) improves viewability.

Methods for compensating for interframe motion in medical imaging are well known in the prior art (see for example U.S. Pat. No. 5,924, 990 showing automatic compensation or Eigler, et al I Circulation. 1994; 89; 2700-2709 showing manual methods, both which are incorporated by reference for all purposes as if fully set forth herein). Typically, automatic methods detect and quantify movement by comparing pairs of consecutive frames through, for example, template-matching or cross-correlation implemented using the Fourier-transformation. Once motion is detected, a reduced frame is defined for each frame compensating for the motion. The series of reduced frames is characterized by the fact that the image of the object of interest appears in the same place within the reduced frame throughout the series.

In FIG. 1, the image of the object of interest 10 apparently moves across the field of view when frame 30, frame 32, and frame 34 are viewed successively, as can be seen by the coordinates (b,d), (c,d), and (d,d), respectively, of image 10 in each frame. By applying tracking method 12 to the data making up frames 30, 32, and 34, reduced frame 31 is derived from frame 30, reduced frame 33 is derived from frame 32, and reduced frame 35 is derived from frame 34. When the series of reduced frames 31, 33 and 35 are viewed successively, image 10 does not appear to move across the field of view.

This process also eliminates vibrations in the frame rendering the series clearer when viewed in the continuous cine mode. In FIG. 2, image 10 apparently vibrates and jiggles in the field of view when frame 36, frame 38, and frame 40 are viewed successively, as can be seen by the coordinates (c,c), (c,d), and (d,c), respectively, of image 10 in each frame. By applying a method to steady the image 14 to the data making up frames 36, 38, and 40, reduced frame 37 is derived from frame 36, reduced frame 39 is derived from frame 38, and reduced frame 41 is derived from frame 40. When the series of reduced frames 37, 39 and 41 are viewed successively, image 10 does not appear to vibrate and jiggle.

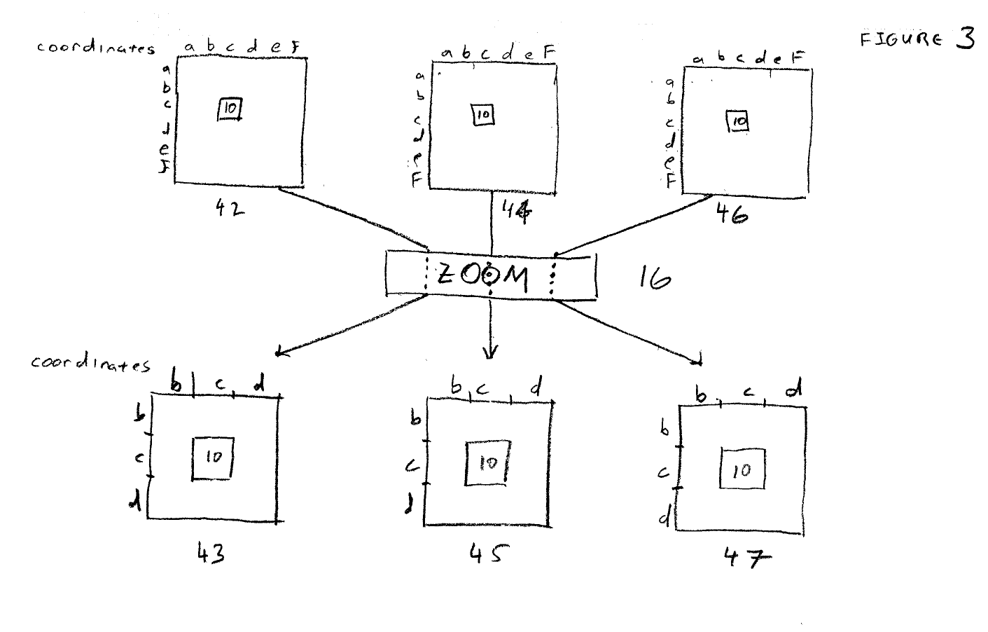

Once the location of the image of the object of interest in each reduced frame is known, extraneous data from each reduced frame can be discarded. In FIG. 3, image 10 appears in the same place in frame 42, frame 44, and frame 46, as can be seen by the fact that the coordinates of image 10 are (c,c) in each frame. By applying a digital zoom method 16 to the data making up frames 42, 44, and 46, reduced frame 43 is derived from frame 42, reduced frame 45 is derived from frame 44, and reduced frame 47 is derived from frame 46. As can be seen from viewing the coordinates, whereas the data representing image 10 is not affected, the total amount of data is reduced to 25% as can be seen by comparing the coordinates of reduced frames 43, 45, and 47 to the coordinates of 42, 44 and 46. Methods for performing digital zoom and discarding or compressing extraneous data are well known in the art.

It is clear that in the three methods discussed tracking, steadying the image and zooming-in, it is possible to define the reduced frame so that the image of the object of interest appears in the center of the field of view.

With or without application of the steps of centering, tracking or steadying the image, or performing digital zoom to generate the series of reduced frames, this invention further includes a method of identifying and isolating a reduced series of frames or reduced frames that define one period of a periodic variation, when a periodic variation is present in the data.

To this end, a one-dimensional closeness function is constructed, wherein each value in the closeness function is related to the similarity of a pair of consecutive frames. This closeness function is then analyzed to identify a periodicity having a frequency corresponding to the periodic variation of interest, in the case of X-ray angiography, a heartbeat.

The value corresponding to the smallest change between two successive frames is identified in the closeness function. One period's-worth of frames is selected starting with the second of the two frames as the desired reduced series of frames. In the case of X-ray angiography, the two consecutive frames that are most similar often correspond to the end diastolic phase of the cardiovascular cycle. Selecting the reduced series in such a manner improves viewability in the continuous cine mode as image jumping or jitter when passing from the last to the first image is minimized.

In a preferred embodiment of the invention, only the first period's-worth of values of the closeness function is examined and the value corresponding to the smallest change between two successive frames is identified in the first period's-worth of values of the closeness function.

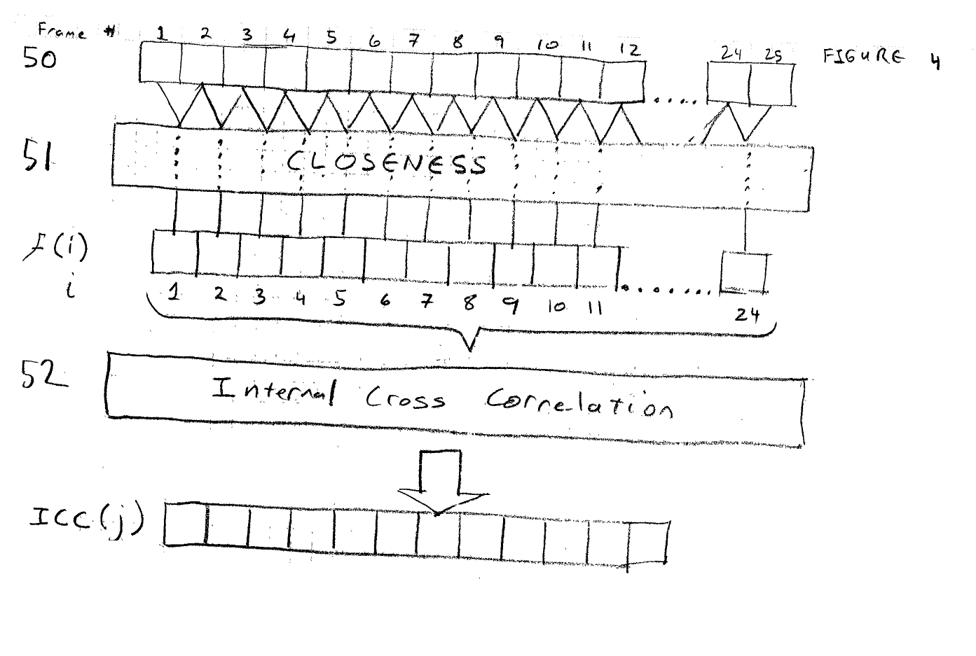

This method can be more easily understood with reference to FIG. 4. Consider a run 50 made up of 25 frames. 24_membered closeness function f, where f(i)=closeness(i, i+1), is generated. The arguments for function f are two frames. The method to generate closeness function f from run 50 is designated 51 in FIG. 4. Methods for generation of closeness functions from digital data representing pairs of images are well known to one skilled in the art, see for example U.S. Pat. No. 5,924,990 column 10 line 31 through column 11 line 41.

After closeness function f is generated, the periodicity of f is found. Many methods exist to identify periodicity in such a function, e.g., Fourier transformation or an internal cross-correlation algorithm 52. When using internal cross-correlation according to the invention, the closeness function f is correlated with itself for every applicable lag j to generate the internal cross-correlation for every lag, ICC(j):

$$ICC ( j ) = \frac{{\sum }_{i} f ( i ) \cdot f ( i + j )}{{( {\sum }_{i} {f}^{2} ( i ) \cdot {\sum }_{i} {f}^{2} ( i + j ) )}^{0 \; 5}}$$

Lag j can be found using both a normalized internal cross-correlation (above) and a not normalized cross-correlation:

$$ICC ( j ) = {\sum }_{i} f ( i ) \cdot f ( i + j )$$

The lag that has the highest correlation value is the period of the correlation function and therefore a periodicity that is found in the series of frames. This periodicity is the periodicity that corresponds to the periodic variation of interest.

A more preferred embodiment of the invention involves dividing the cross-correlation function into multiple cross-correlation subfunctions. A value of j is found for each such subfunction independently. If all the values of j from each of the subfunctions are similar, e.g. within 1 frame of each other, there is added confidence that the periodicity found is the cardiovascular periodicity.

To improve viewability in the continuous cine mode, the first frame of the reduced series of frames is carefully chosen. The first and last frame should be as similar as possible so as to reduce the image jumping when going from the last to the first frame. To select the optimal first frame, the first periods-worth of values of the closeness function {f(1) . . . f(j)} are considered, and value which represents the least change between two successive frames is selected. The second of the two frames that gave rise to this value is defined as first frame in the reduced series that is composed of a total of j frames. Thus, if one period was found to be seven frames long ( j+7), and the third value of the closeness function f(3)=closeness (3 , 4) indicated the greatest similarity, then the reduced series consists of frames 4 through 10.

Definition of a reduced series of reduced frames using this invention significantly reduces the amount of data required to represent a series of periodic time-dependent images by limiting the spatial data to the object of interest and the temporal data to one period. In many applications, such as X-ray angiography all diagnostically significant information is retained.

Clearly, application of this invention is not limited to X-ray angiography data. This invention can be applied to data from other medical imaging techniques, such as ultrasound and Echocardiography, and also to any digital data recording or representing a series of time-dependent images.

If the imaging device supplies the images as digital data, application of the invention can be done by the imaging system itself. It is also possible to transfer the digital data from the imaging device to an additional system, for instance, a Picture Archiving and Communication System (PACS) and to apply the invention by the PACS. If the imaging device supplies the images as analog or video data, it is necessary to convert the analog or video data to digital data, either by the PACS, or by another suitable system or device before application of the invention.

While the invention has been described with respect to a limited number of embodiments, it will be appreciated that many variations, modifications and other applications may be made without exceeding the spirit and scope of the present invention.

What is claimed is:

1. A method for compressing digital data representing a series of periodic time-dependent images of an object of interest, comprising the steps of:
a. providing a series of digital frames, said digital frames representing the series of periodic time-dependent images, to be compressed;
b. identifying of a number of frames corresponding to one period of said series;
c. designating an optimal first frame; and
d. isolating as desired compressed digital data said optimal first frame and a set of immediately succeeding frames equal in number to said number of frames less one.

2. The method as in claim 1, further comprising the step of displaying said desired compressed digital data.

3. The method as in claim 1 further comprising the step, of storing said desired compressed digital data.

4. The method as in claim 1 further comprising the step of transmitting said desired compressed digital data.

5. The method of claim 1 further comprising at least one step selected from the group consisting of:
a. digitally processing each said frame of said series so as to center the image of the object of interest in said each frame;
b. digitally processing each said frame of said series so as to stabilize the image of the object of interest in said each frame; and
c. digitally processing each said frame of said series so as to retain substantially only said image of said object of interest in said each frame.

6. The method as in claim 1 wherein said identifying of said number of frames corresponding to one period of said series, includes the steps of:
i. providing a closeness function of said frames;
ii. deriving a periodicity of said closeness function; and
iii. deriving said number of images from said periodicity.

7. The method as in claim 6 wherein said designating of said optimal first frame includes the steps of:
i. identifying an extreme value in said closeness function, said extreme value corresponding to a greatest similarity between two consecutive said frames; and
ii. designating a second of said consecutive frames as said optimal first frame.

8. The method as in claim 1 wherein said providing of said series of digital frames to be compressed is effected by steps including recording a series of images by imaging means.

9. The method as in claim 8 wherein said imaging means are part of a medical imaging device.

10. The method as in claim 9 wherein said medical imaging device is an X-ray angiography imaging system.

11. The method of claim 9 wherein said medical imaging device is an ultrasound imaging system.

12. The method of claim 9 wherein said medical imaging device is an echocardiography imaging system.

13. The method as in claim 1 wherein said providing of said series of digital frames to be compressed is effected by steps including transferring the series of images to a Picture Archiving and Communication System.

14. The method as in claim 1 wherein said providing of said series of digital frames to be compressed is effected by steps including transferring said series of digital frames to a Picture Archiving and Communication System.

15. The method as in claim 1 wherein said one period corresponds to one cardiovascular period.

16. The method as in claim 1 wherein said optimal first image corresponds to an end diastolic phase of a cardiovascular period.

17. A method for compressing digital data representing a series of time-dependent images of an object of interest comprising the steps of:
a) providing a series of digital frames, said digital frames representing the series of time-dependent images, to be compressed; and
b) generating desired compressed digital data by performing at least one step selected from the group consisting of:
i) digitally processing each said frame of said series so as to center the image of the object of interest in said each frame;
ii) digitally processing each said frame of said series so as to stabilize the image of the object of interest in said each frame; and
iii) digitally processing each said frame of said series so as to retain substantially only said image of said object of interest in said each frame.

18. The method as in claim 17, further comprising the step of displaying said desired compressed digital data.

19. The method as in claim 17 further comprising the step of storing said desired compressed digital data.

20. The method as in claim 17 further comprising the step of transmitting said desired compressed digital data.

21. The method as in claim 17 wherein said providing of said series of digital frames to be compressed is effected by steps including recording a series of images by imaging means.

22. The method as in claim 21 wherein said imaging means are part of a medical imaging device.

23. The method as in claim 22 wherein said medical imaging device is an X-ray angiography imaging system.

24. The method of claim 22 wherein said medical imaging device is an ultrasound imaging system.

25. The method of claim 22 wherein said medical imaging device is an echocardiography imaging system.

26. The method as in claim 17 wherein said providing of said series of digital frames to be compressed is effected by steps including transferring the series of images to a Picture Archiving and Communication System.

27. The method as in claim 17 wherein said providing of said series of digital frames to be compressed is effected by steps including transferring said series of digital frames to a Picture Archiving, and Communication System.
